(19) United States
(12) Patent Application Publication
(10) Pub. No.: US 2005/0039777 A1
(43) Pub. Date: Feb. 24, 2005

(54) Device and method for washing items in a dishwasher

(75) Inventors: Helmut Jerg, Giengen (DE); Michael Rosenbauer, Reimlingen (DE); Bernd Schessl, Dillingen (DE)

Correspondence Address: LERNER AND GREENBERG, PA, P O BOX 2480, HOLLYWOOD, FL, 33022-2480, US

(73) Assignee: BSH Bosch und Siemens Hausgerate GmbH

(21) Appl. No.: 10/873,477

(22) Filed: Jun. 21, 2004

Related U.S. Application Data
(63) Continuation of application No. PCT/EP02/12834, filed on Nov. 15, 2002.

(30) Foreign Application Priority Data
Dec. 19, 2001 (DE) 101 62 501.4

(51) Int. Cl. B08B 3/00

(52) U.S. Cl. 134/18; 134/25.2; 134/57 D; 134/137; 134/200

(57) ABSTRACT

A device and a method enable items disposed in at least one dish rack of a dishwasher and having different degrees of dirtiness or soiling to be cleaned in an optimum manner, according to the degree of dirtiness or soiling. The device for washing items includes a control mechanism for controlling specific areas of a spraying device during a washing process. The spraying device is integrated into the at least one dish rack. The method for washing items includes supplying washing liquid from specific areas of the spraying device disposed below the dish rack to regions of the dish rack disposed directly above in a targeted manner through blocking devices respectively associated with the specific areas. Each specific area is controlled by a control mechanism.

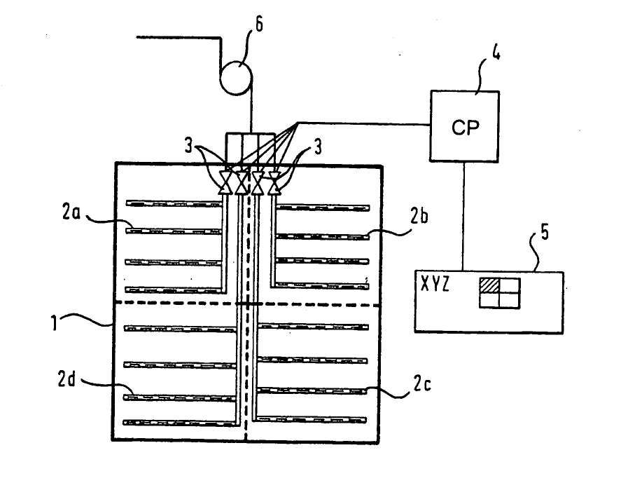

### CROSS-REFERENCE TO RELATED APPLICATION

This application is a continuation, under 35 U.S.C. § 120, of copending International Application No. PCT/EP02/12834, filed Nov. 15, 2002, which designated the United States; this application also claims the priority, under 35 U.S.C. § 119, of German Patent Application 101 62 501.4, filed Dec. 19, 2001; the prior applications are herewith incorporated by reference in their entirety.

### BACKGROUND OF THE INVENTION

Field of the Invention

The present invention relates to a device and a method for cleaning items to be washed in a dishwasher having at least one dish rack.

German Published, Non-Prosecuted Patent Application DE 27 02 644 discloses a dish rack for dishwashers, which provides tubes in a storage region each having openings to supply a rinse fluid to the items to be washed which are disposed directly above. During a wash cycle, rinse fluid travels through all of the openings of the tubes formed as a supply line into the dish rack. Due to the narrow supply tubes there is a marked drop in pressure up to the point farthest from the inflow of the tubes. For that reason, the wash or spray capacity is not configured equally in all regions of the dish rack. Therefore, in those regions farthest from the inflow, the spray jet strikes the items to be washed at a diminished speed.

That disadvantage is all the more serious if particularly stubborn items to be washed are stacked in those regions of the dish rack remote from the inflow, resulting in a varying wash quality in a dish rack.

### SUMMARY OF THE INVENTION

It is accordingly an object of the invention to provide a device and a method for washing items in a dishwasher which overcome the hereinafore-mentioned disadvantages of the heretofore-known devices and methods of this general type and which enable items to be washed that are stacked in a dish rack with varying dirtiness or soiling to be cleaned optimally according to the degree of dirtiness or soiling.

With the foregoing and other objects in view there is provided, in accordance with the invention, a device for cleaning items to be washed in a dishwasher. The device comprises at least one dish rack. A spraying device has specific areas and the spraying device is integrated with the at least one dish rack. A control mechanism is associated with the spraying device for controlling the specific areas of the spraying device during washing.

In accordance with another feature of the invention, the spraying device is disposed under the dish rack and, in particular, is configured as a spray floor.

In accordance with a further feature of the invention, the spraying device is to be divided into individual sections, preferably quadrants, which are in each case to be blocked off from the other areas by a blocking device, so that the control mechanism for controlling specific areas can supply the rinse fluid precisely to individual areas. In this way, those items to be washed with stubborn dirt can be supplied more intensively with rinse liquid, whereas other areas, for example stacked only with glasses, receive less intensive spray treatment.

In accordance with an added feature of the invention, there are provided rotary spray arms. A rotating or rotatable spray arm is disposed in each specific area to form the spraying devices. The areas are preferably configured as quadrants.

In accordance with a concomitant feature of the invention, the selectable areas are configured separately from one another by the blocking devices.

With the objects of the invention in view, there is also provided a method for cleaning items to be washed in a dishwasher. The method comprises providing at least one dish rack having regions and placing a spraying device having specific areas under the at least one dish rack. Washing liquid is supplied from each of the specific areas of the spraying device to a respective one of the regions of the at least one dish rack located directly above. The supply is carried out through blocking devices each assigned to a respective one of the regions of the at least one dish rack. Washing through the use of the specific areas of the spraying device is controlled by a control mechanism.

The advantage of the device and method according to the invention is that consumption or usage values, in particular water and power consumption values, are optimized for the respective wash cycles, i.e. the water consumption or the power consumption drops on average.

The device and the method according to the invention can be utilized both in domestic and commercial dishwashers, as well as both in the upper and the lower rack in these respective devices, and in each case are used separately in only one dish rack.

Other features which are considered as characteristic for the invention are set forth in the appended claims.

Although the invention is illustrated and described herein as embodied in a device and a method for washing items in a dishwasher, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The figure of the drawing is a diagrammatic, plan view of an embodiment of a dish rack and spraying device as well as, inter alia, a block diagram of a control mechanism and operating panel, for explaining the device and method according to the invention.

### DESCRIPTION OF THE PREFERRED EMBODIMENTS

Referring now in detail to the single figure of the drawing, there is seen a dish rack 1 according to the invention with a spraying device 2a-2d. Specific areas of the spraying device 2a-2d each terminate separately or individually in a blocking or shut-off device 3.

The spraying device 2a-2d is disposed under the dish rack 1 and, in the illustrated embodiment, is configured as a spraying floor, which can be individually divided up into the specific areas. In the illustrated embodiment, the specific areas are configured as quadrants. A supply area which leads to the blocking device 3 is funnelled in the direction of a circulating pump 6, thus configuring a central area, from which respective influx areas supply the spraying device 2a-2d above the blocking device 3. In the illustrated embodiment the blocking devices 3 are configured as magnetic valves. Each of the individual specific areas is configured in such a way that a blocking device 3 can block it off from the other areas.

The blocking devices 3 are controlled by a control mechanism 4, which is in turn connected to or integrated in a non-illustrated control mechanism of the dishwasher, so that respective control rhythms, which control wash cycles, are backed up in a control program CP. In order to drive the respective specific areas of the spraying device 2a-2d as they are selected, the control mechanism 4 is connected to an operating panel 5, which includes a diagrammatic illustration of the specific areas of the spraying device 2a-2d and advantageously displays the specific areas selected in each case through the use of lighting elements, indicated in the figure by letters XYZ. In the illustrated embodiment with selected division into quadrants, i.e. division of a substantially square configured dish rack 1 into four equal-sized surfaces, a keypad with four keys is provided on a console of the operational element 5, which represent the respective quadrants, provided for a more intensive wash cycle.

Due to the division into quadrants, i.e. division of a substantially square configured dish rack into four equal-sized surfaces, a keypad with four keys can be provided on a console of the operation panel 5. The keys represent the respective quadrants, provided for a more intensive wash cycle.

In selecting the respective quadrants or zones the user can select a region of the dish rack to be washed more intensively by actuating the corresponding keys, as long as the selection is done manually. The method according to the invention is to be selected appropriately and optionally, or provided in specific wash cycles. In addition to selection of the respective regions it is also possible to alter spray jet intensity where, for example, a speed control of the circulating pump motor is changed, and thus an exit rate of the spray jet can correspondingly be matched to respective requirements. In addition to the option of the user making the region selection manually through the console, it is also possible according to the present invention to recognize those items to be washed with particularly stubborn soiling through the use of sensors housed in the wash container, for example through the use of a camera, and to manually select or effect an automatic selection of those respective regions which are to undergo more intensive cleaning during the wash cycle.

Due to the device and the method according to the invention, regions containing items to be washed having stubborn dirt can be sprayed more intensively with rinse fluid, whereas other regions, for example those stacked only with glasses, can undergo less intensive spray treatment. Thus a device and a method are provided, which enable items to be washed that are stacked in a dish rack 1 with varying dirtiness or soiling to be cleaned optimally according to the degree of dirtiness or soiling.

A further advantageous result of the device and the method according to the invention is that usage or consumption values, in particular water and power consumption values, are optimized for the respective wash cycles. In other words, the water consumption or the power consumption drops on average.

1. A device for cleaning items to be washed in a dishwasher, the device comprising:
at least one dish rack;
a spraying device having specific areas, said spraying device being integrated with said at least one dish rack; and
a control mechanism associated with said spraying device for controlling said specific areas of said spraying device during washing.

2. The device according to claim 1, wherein said spraying device is disposed under said dish rack.

3. The device according to claim 2, wherein said spraying device is a spray floor.

4. The device according to claim 3, wherein said spray floor is individually divided into said specific areas.

5. The device according to claim 4, wherein said specific areas of said spray floor are quadrants.

6. The device according to claim 4, which further comprises at least one blocking device for individually closing off at least one of said specific areas of said spray floor from others of said specific areas of said spray floor.

7. The device according to claim 6, wherein said at least one blocking device is at least one valve driven by said control mechanism.

8. The device according to claim 7, wherein said specific areas of said spray floor are four areas, and said at least one valve is four valves each controlling a respective one of said four specific areas of said spray floor, for supplying only a directly controlled one of said four specific areas of said spray floor with rinse fluid.

9. A method for cleaning items to be washed in a dishwasher, the method which comprises the following steps:
providing at least one dish rack having regions;
placing a spraying device having specific areas under the at least one dish rack;
supplying washing liquid from each of the specific areas of the spraying device to a respective one of the regions of the at least one dish rack located directly above, through blocking devices each assigned to a respective one of the regions of the at least one dish rack; and
controlling washing with the specific areas of the spraying device with a control mechanism.
